(19) United States
(12) Patent Application Publication
(10) Pub. No.: US 2025/0047042 A1
(43) Pub. Date: Feb. 6, 2025

(54) Ground Connection Member and Connector

(71) Applicant: Tyco Electronics (Shanghai) Co., Ltd., Shanghai (CN)

(72) Inventors: Zhicheng (Sean) Zhang, Shanghai (CN); Jingtao (Murphy) Zhu, Shanghai (CN); Hope Lu, Shanghai (CN)

(73) Assignee: Tyco Electronics (Shanghai) Co., Ltd., Shanghai (CN)

(21) Appl. No.: 18/793,213

(22) Filed: Aug. 2, 2024

(30) Foreign Application Priority Data
Aug. 2, 2023 (CN) 202310967001.2

(51) Int. Cl. H01R 13/652; H01R 12/72; H01R 13/05; H01R 13/447; H01R 13/639; H01R 13/64; H01R 13/6471

(52) U.S. Cl. CPC H01R 13/652; H01R 13/05; H01R 13/447; H01R 13/639; H01R 13/64; H01R 13/6471; H01R 12/721

(57) ABSTRACT

A ground connection member adapted to electrically interconnect multiple grounding terminals of a connector includes an installation member, a first contact component, and a second contact component. The installation member has opposite first and second sides in a transverse direction of the ground connection member. The first contact component is assembled onto the first side of the installation member, and includes multiple first elastic arms adapted to electrically contact respective ones of the multiple grounding terminals of the connector. The second contact component is assembled onto the second side of the installation member, and includes multiple second elastic arms adapted to electrically contact respective ones of the multiple grounding terminals of the connector.

### CROSS-REFERENCE TO RELATED APPLICATION

This application claims the benefit of Chinese Patent Application No. CN202310967001.2 filed on Aug. 2, 2023, in the State Intellectual Property Office of China, the whole disclosure of which is incorporated herein by reference.

### FIELD OF THE DISCLOSURE

The present disclosure relates to a ground connection member for electrically interconnecting multiple grounding terminals of a connector, and a connector comprising the ground connection member.

### BACKGROUND

In the prior art, in order to improve the resonant frequency of the connector, a ground connection member for electrically interconnecting multiple grounding terminals of the connector is usually installed in the connector. Through this ground connection member, the resonant path of the connector can be shortened to increase the resonant frequency. However, in the prior art, the connector has only a single contact point between the ground connection member and each grounding terminal. As a result of this single contact point design scheme, it is difficult to increase the resonant frequency of the connector to a higher resonant frequency.

### SUMMARY

According to an embodiment of the present disclosure, a ground connection member adapted to electrically interconnect multiple grounding terminals of a connector includes an installation member, a first contact component, and a second contact component. The installation member has opposite first and second sides in a transverse direction of the ground connection member. The first contact component is assembled onto the first side of the installation member, and includes multiple first elastic arms adapted to electrically contact respective ones of the multiple grounding terminals of the connector. The second contact component is assembled onto the second side of the installation member, and includes multiple second elastic arms adapted to electrically contact respective ones of the multiple grounding terminals of the connector.

### BRIEF DESCRIPTION OF THE DRAWINGS

The disclosure will now be described by way of example with reference to the accompanying Figures, of which:

FIG. 1 shows an illustrative perspective view of a connector according to an exemplary embodiment of the present disclosure;

FIG. 2 shows an illustrative transverse sectional view of a connector according to an exemplary embodiment of the present disclosure;

FIG. 3 shows an illustrative transverse plan sectional view of a connector according to an exemplary embodiment of the present disclosure;

FIG. 4 shows an illustrative transverse plan sectional view of a connector according to an exemplary embodiment of the present disclosure, where the upper and lower cover plates are not shown;

FIG. 5 shows an illustrative perspective view of the upper and lower cover plates of a connector according to an exemplary embodiment of the present disclosure;

FIG. 6 shows an illustrative perspective view of the upper and lower rows of terminals and the ground connection member of a connector according to an exemplary embodiment of the present disclosure;

FIG. 7 shows an illustrative perspective view of a ground connection member of a connector according to an exemplary embodiment of the present disclosure; and

FIG. 8 shows an illustrative exploded view of the ground connection member of a connector according to an exemplary embodiment of the present disclosure.

### DETAILED DESCRIPTION OF THE EMBODIMENTS

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to an embodiment of the present disclosure, a ground connection member for electrically interconnecting multiple grounding terminals of a connector is provided. The ground connection member includes an installation member having opposite first and second sides in a transverse direction of the ground connection member, a first contact component assembled onto the first side of the installation member, and a second contact component assembled onto the second side of the installation member. The first contact component comprises multiple first elastic arms for electrical contact with the multiple grounding terminals of the connector, respectively, The second contact component comprises multiple second elastic arms for electrical contact with the multiple grounding terminals of the connector, respectively.

According to another embodiment of the present disclosure a connector is provided. The connector comprises a housing, multiple terminals provided in the housing including multiple signal terminals and multiple grounding terminals, and the above described ground connection member provided in the housing. The multiple first elastic arms of the first contact component are in electrical contact with the multiple grounding terminals respectively. The multiple second elastic arms of the second contact are in electrical contact with the multiple grounding terminals respectively, so that each grounding terminal is in electrical contact with both the first elastic arm and the second elastic arm simultaneously.

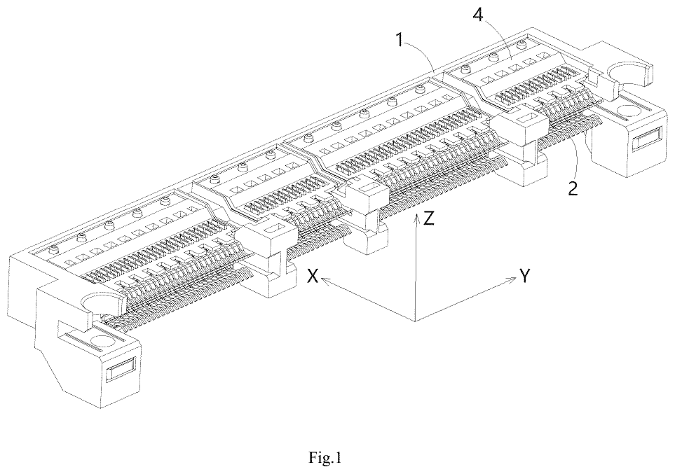

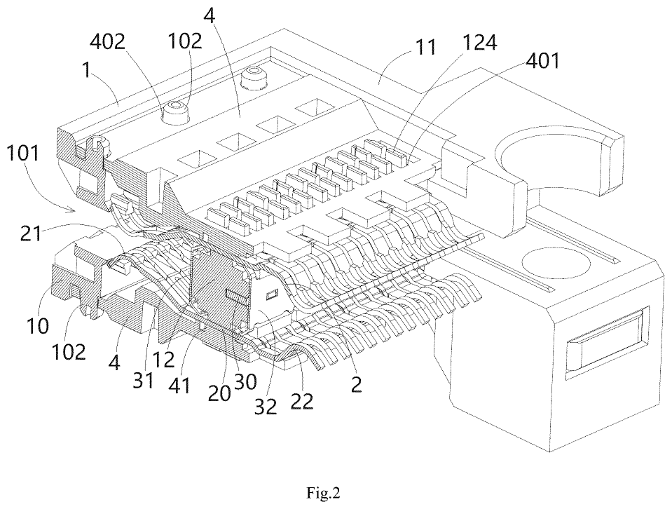

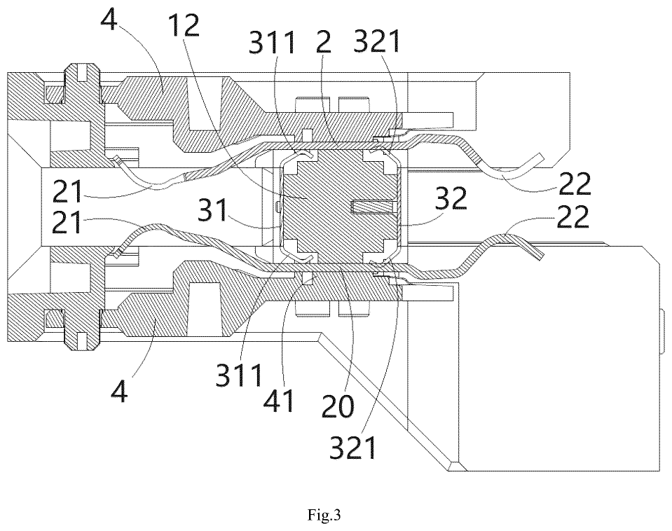

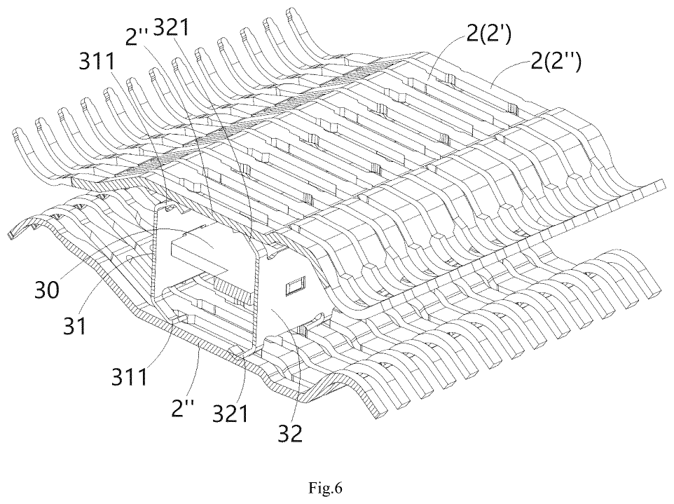

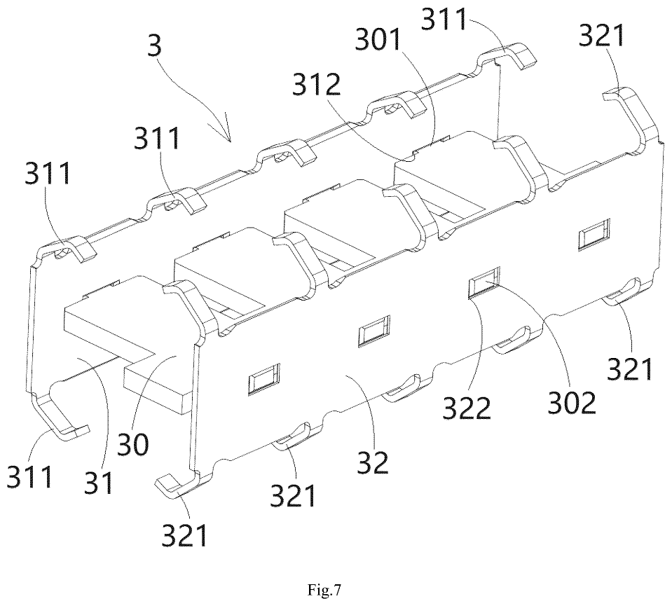

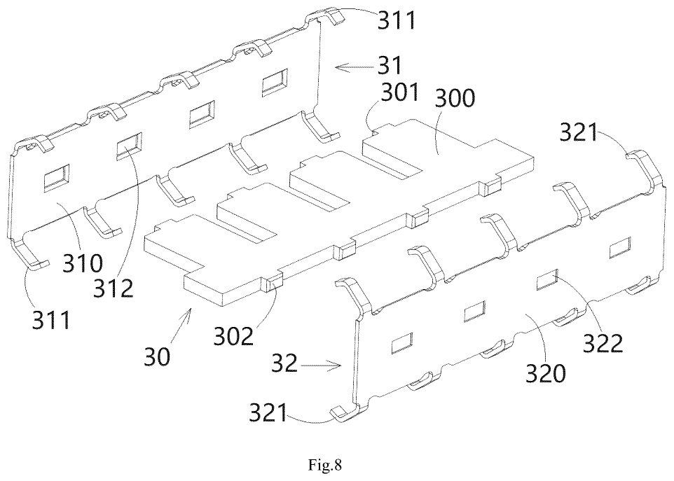

FIG. 1 shows an illustrative perspective view of a connector according to an exemplary embodiment of the present disclosure. FIG. 2 shows an illustrative transverse sectional view of a connector according to an exemplary embodiment of the present disclosure. FIG. 3 shows an illustrative transverse plan sectional view of a connector according to an exemplary embodiment of the present disclosure. FIG. 6 shows an illustrative perspective view of the upper and lower terminals and the ground connection member of a connector according to an exemplary embodiment of the present disclosure. FIG. 7 shows an illustrative perspective view of the ground connection member of a connector according to an exemplary embodiment of the present disclosure. FIG. 8 shows an illustrative exploded view of the ground connection member of a connector according to an exemplary embodiment of the present disclosure.

As shown in FIGS. 1-3 and 6-8, in an exemplary embodiment of the present disclosure, a ground connection member 3 is disclosed, which is used for electrically interconnecting multiple grounding terminals 2″ of a connector. The ground connection member 3 includes an installation member 30, a first contact component 31, and a second contact component 32. The installation member 30 has a first side and a second side opposite to each other in the transverse direction X of the ground connection member 3. The first contact component 31 is assembled onto the first side of the installation member 30. The second contact component 32 is assembled onto the second side of the installation member 30. The first contact component 31 includes multiple first elastic arms 311, which are used for respectively electrical contact with multiple grounding terminals 2″ of the connector. The second contact 32 includes multiple second elastic arms 321, which are used for respectively electrical contact with multiple grounding terminals 2″ of the connector.

Each grounding terminal 2″ of the connector is in electrical contact with both the first elastic arm 311 and the second elastic arm 321. Therefore, the ground connection member 3 has two contact points with each grounding terminal 2″ of the connector, which can increase the resonant frequency of the connector to a higher resonant frequency. For example, the resonant frequency of the connector can be increased to 21.5 GHz, meeting consumer requirements.

In the illustrated embodiment, the first contact component 31 further comprises a first body 310 and multiple first elastic arms 311. The multiple first elastic arms 311 are connected to the side edge of the first body 310. The second contact component 32 further includes a second body 320 and multiple second elastic arms 321. The multiple second elastic arms 321 are connected to the side edge of the second body 320. The first body 310 and the second body 320 are assembled onto the first and second sides of the installation member 30, respectively.

Multiple first holes 312 are formed in the first body 310, and multiple first protrusions 301 are formed on the first side of the installation member 30. The multiple first protrusions 301 are respectively inserted into multiple first holes 312 to assemble the first body 310 onto the first side of the installation member 30. Multiple second holes 322 are formed in the second body 320, and multiple second protrusions 302 are formed on the second side of the installation member 30. Multiple second protrusions 302 are respectively inserted into multiple second holes 322 to assemble the second body 320 onto the second side of the installation member 30.

The installation member 30, the first body 310, and the second body 320 are in a plate shape, and the first body 310 and the second body 320 are perpendicular to the installation member 30. Therefore, in the illustrated embodiment, the cross-section of the ground connection member 3 in its transverse direction X is H-shaped.

The installation member 30, the first contact component 31, and the second contact component 32 may be made of the same or different metal materials. For example, the installation member 30, the first contact component 31, and the second contact component 32 can be made of copper, steel, aluminum, or alloy.

The first body 310 has opposite upper and lower sides in the height direction Z of the ground connection member 3. Multiple first elastic arms 311 are symmetrically distributed on the upper and lower sides of the first body 310. The second body 320 has opposite upper and lower sides in the height direction Z of the ground connection member 3. Multiple second elastic arms 321 are symmetrically distributed on the upper and lower sides of the second body 320.

The first elastic arms 311 on the upper side of the first body 310 are used for respectively electrical contact with the grounding terminals 2″ in the upper row of terminals 2 of the connector. The second elastic arms 321 on the upper side of the second body 320 are used for respectively electrical contact with the grounding terminals 2″ in the upper row of terminals 2 of the connector. The first elastic arms 311 on the lower side of the first body 310 are used for respectively electrical contact with the grounding terminals 2″ in the lower row of terminals 2 of the connector. The second elastic arms 321 on the lower side of the second body 320 are used for respectively electrical contact with the grounding terminals 2″ in the lower row of terminals 2 of the connector.

The first contact component 31 and the second contact component 32 each is an integral stamped piece. The first contact component 31 and the second contact component 32 are identical. This allows them to be interchangeable, reducing manufacturing costs.

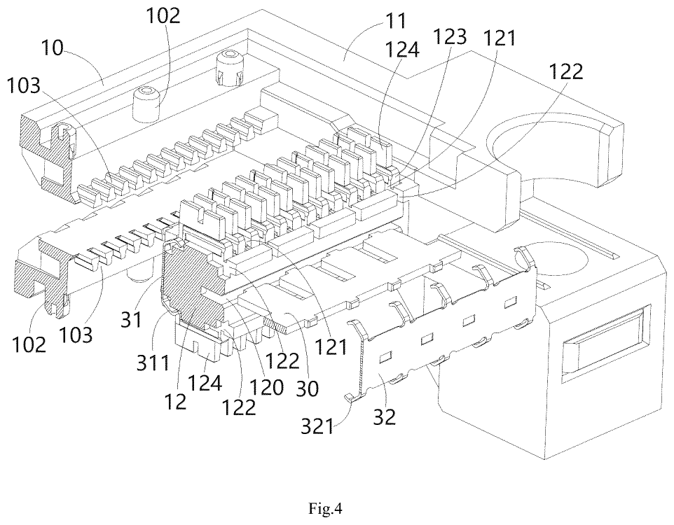

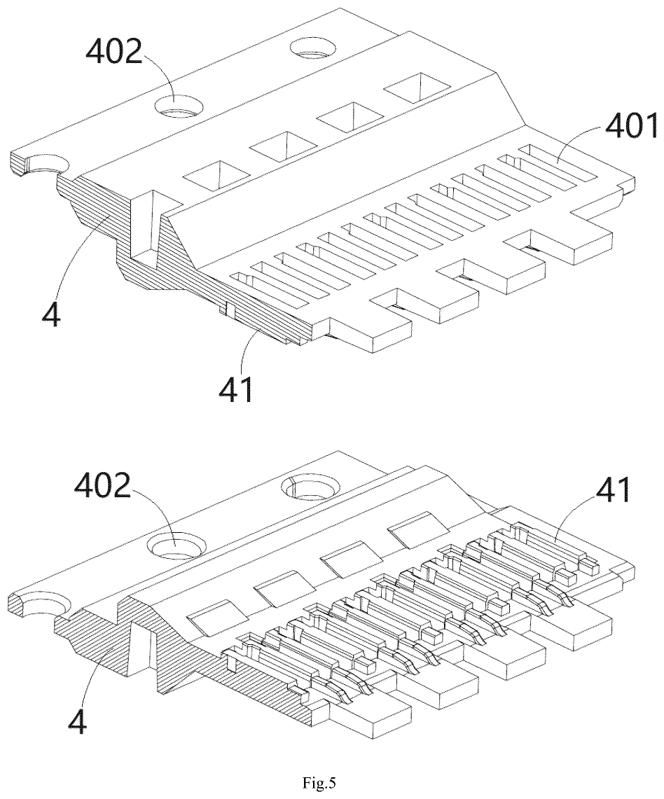

FIG. 4 shows an illustrative transverse plan sectional view of a connector according to an exemplary embodiment of the present disclosure, where the upper and lower cover plates 4 are not shown. FIG. 5 shows an illustrative perspective view of the upper and lower cover plates 4 of a connector according to an exemplary embodiment of the present disclosure.

As shown in FIGS. 1-8, in an exemplary embodiment of the present disclosure, a connector is disclosed. The connector includes: a housing 1, multiple terminals 2, and the aforementioned ground connection member 3. Multiple terminals 2 are provided in the housing 1 and include multiple signal terminals 2′ and multiple grounding terminals 2″. The ground connection member 3 is installed in the housing 1. Multiple first elastic arms 311 of the first contact component 31 are respectively in electrical contact with multiple grounding terminals 2″, and multiple second elastic arms 321 of the second contact component 32 are respectively in electrical contact with multiple grounding terminals 2″, so that each grounding terminal 2″ is in electrical contact with one first elastic arm 311 and one second elastic arm 321 simultaneously.

As shown in FIGS. 1 to 8, in the illustrated embodiments, the terminal 2 and the ground connection member 3 are detachably assembled into the housing 1, allowing the terminal 2 and the ground connection member 3 to be replaced.

As shown in FIGS. 1 to 8, in the illustrated embodiments, multiple terminals 2 are arranged in an upper row and a lower row, multiple first elastic arms 311 are arranged in an upper row and a lower row, and multiple second elastic arms 321 are arranged in an upper row and a lower row. The upper row of first elastic arms 311 are respectively in electrical contact with the grounding terminals 2″ in the upper row of terminals 2, and the upper row of second elastic arms 321 are respectively in electrical contact with the grounding terminals 2″ in the upper row of terminals 2. The lower row of first elastic arms 311 are respectively in electrical contact with the grounding terminals 2″ in the lower row of terminals 2, and the lower row of second elastic arms 321 are respectively in electrical contact with the grounding terminals 2″ in the lower row of terminals 2.

As shown in FIGS. 1 to 8, in the illustrated embodiments, the housing 1 comprises a pair of end walls 11 and a retaining body 12. The pair of end walls 11 are opposite in the longitudinal direction Y of the housing 1. The retaining body 12 is connected between the pair of end walls 11 and extends along the longitudinal direction Y. A row of terminal installation slots 121 are formed on each of the upper and lower sides of the retaining body 12. The upper row of terminals 2 are kept in the upper row of terminal installation slots 121, and the lower row of terminals 2 are kept in the lower row of terminal installation slots 121.

As shown in FIGS. 1 to 8, in the illustrated embodiments, the retaining body 12 has opposite front and rear sides in the transverse direction X of the housing 1. The terminal 2 includes: a first cantilever portion 21, a second cantilever portion 22, and a middle connection portion 20. The first cantilever portion 21 extends from the front side of the retaining body 12 for electrical contact with the inserted first circuit card (not shown). The second cantilever portion 22 extends from the rear side of the retaining body 12 for electrical contact with the inserted second circuit card (not shown). The middle connection portion 20 is connected between the first cantilever portion 21 and the second cantilever portion 22. The middle connection portion 20 is installed and maintained in the terminal installation slot 121 of the retaining body 12.

As shown in FIGS. 1 to 8, in the illustrated embodiments, a horizontal slot 120 is formed on the retaining body 12 perpendicular to the height direction Z of the housing 1, and the installation member 30 of the ground connection member 3 is inserted into the horizontal slot 120. The first contact component 31 and the second contact component 32 of the ground connection member 3 are located on the front and rear sides of the retainer 12, respectively, and are assembled on both sides of the installation member 30.

As shown in FIGS. 1 to 8, in the illustrated embodiments, multiple accommodating slots 122 are formed on the front and rear sides of the retaining body 12, respectively, and each accommodating slot 122 is communicated with a corresponding terminal installation slot 121. The first elastic arm 311 and the second elastic arm 321 are respectively accommodated in the accommodating slots 122 on the front and rear sides of the retaining body 12, and are in electrical contact with the middle connection portion 20 of the grounding terminal 2″.

As shown in FIGS. 1 to 8, in the illustrated embodiments, the connector further comprises a pair of cover plates 4. The pair of cover plates 4 are installed on the upper and lower sides of the housing 1, respectively, to keep the upper row of terminals 2 and the lower row of terminals 2 in the upper row of terminal installation slots 121 and the lower row of terminal installation slots 121 of the retaining body 12, respectively.

As shown in FIGS. 1 to 8, in the illustrated embodiments, a rib 41 is formed on the cover plate 4, which is inserted into the terminal installation slot 121 to press the middle connection portion 20 of terminal 2 in the terminal installation slot 121.

As shown in FIGS. 1 to 8, in the illustrated embodiments, a slot hole 401 is formed on the cover plate 4, and a protruding tongue 124 is formed on the top surface of the side wall 123 of the terminal installation slot 121, the protruding tongue 124 is inserted into the slot hole 401.

As shown in FIGS. 1 to 8, in the illustrated embodiments, the housing 1 further comprises a front wall 10, which is connected between the pair of end walls 11 and spaced at a predetermined distance from the retaining body 12 in the transverse direction X. A post 102 is formed on each of the upper and lower sides of the front wall 10, and an insertion hole 402 is formed in the cover plate 4. The posts 102 are inserted into the insertion holes 402.

As shown in FIGS. 1 to 8, in the illustrated embodiment, two rows of positioning grooves 103 are formed on the inner side of the front wall 10. The ends of the first cantilever portions 21 of the upper row of terminals 2 and the lower row of terminals 2 are positioned in the upper and lower rows of positioning grooves 103, respectively. A card slot 101 extending along the longitudinal direction Y is formed on the front wall 10 to allow the first circuit card to be inserted between the first cantilever portions 21 of the upper row of terminals 2 and the first cantilever portions 21 of the lower row of terminals 2 through the card slot 101.

As shown in FIGS. 1 to 8, in the illustrated embodiments, the dual contact points design of the ground connection member can greatly shorten the resonant path of the connector, greatly increase the resonant frequency of the connector, and reduce signal crosstalk. In the illustrated embodiment, the dual contact points design of the ground connection member can increase the resonant frequency of the connector to 21.5 GHz.

As shown in FIGS. 1 to 8, in the illustrated embodiments, the ground connection member of the present disclosure is compatible with existing connector products and does not require redesigning components such as terminal 2 and cover plate 4. Moreover, the combined ground connection member of the present disclosure has a simple structure and is easier to manufacture. Elastic contact design is beneficial for manufacturing, avoiding quality risks such as plastic melting/coking caused by welding, and also avoiding possible positional deviations of upper and lower terminal blocks and even cover plates caused by welding, hard drying, and other designs. Therefore, the present disclosure will not affect the overall signal integrity performance of the connector product.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present disclosure are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A ground connection member adapted to electrically interconnect multiple grounding terminals of a connector, comprising:
an installation member having opposite first and second sides in a transverse direction of the ground connection member;
a first contact component assembled onto the first side of the installation member, the first contact component including multiple first elastic arms adapted to electrically contact respective ones of the multiple grounding terminals; and
a second contact component assembled onto the second side of the installation member, the second contact component including multiple second elastic arms adapted to electrically contact respective ones of the multiple grounding terminals.

2. The ground connection member according to claim 1, wherein:
the first contact component further includes a first body, multiple first elastic arms are connected to a side edge of the first body;
the second contact component further includes a second body, multiple second elastic arms are connected to a side edge of the second body; and
the first body and the second body are assembled onto respective ones of the first and second sides of the installation member.

3. The ground connection member according to claim 2, wherein:
multiple first holes are formed in the first body, multiple first protrusions are formed on the first side of the installation member and are inserted into the multiple first holes to assemble the first body onto the first side of the installation member; and
multiple second holes are formed in the second body, multiple second protrusions are formed on the second side of the installation member and are inserted into the multiple second holes to assemble the second body onto the second side of the installation member.

4. The ground connection member according to claim 3, wherein the installation member, the first body, and the second body are in a plate shape, and the first body and the second body are oriented perpendicular to the installation member.

5. The ground connection member according to claim 4, wherein:
the first body has opposite upper and lower sides in a height direction of the ground connection member, and multiple first elastic arms are symmetrically distributed on the upper and lower sides of the first body; and
the second body has opposite upper and lower sides in the height direction of the ground connection member, and multiple second elastic arms are symmetrically distributed on the upper and lower sides of the second body.

6. The ground connection member according to claim 5, wherein:
the first elastic arms on the upper side of the first body are adapted to electrically contact the grounding terminals in the upper row of terminals of the connector, and the second elastic arms on the upper side of the second body are adapted to electrically contact the grounding terminals in the upper row of terminals of the connector; and
the first elastic arms on the lower side of the first body are adapted to electrically contact the grounding terminals in the lower row of terminals of the connector, and the second elastic arms on the lower side of the second body are adapted to electrically contact the grounding terminals in the lower row of terminals of the connector.

7. The ground connection member according to claim 1, wherein the cross-section of the ground connection member is H-shaped in its transverse direction.

8. The ground connection member according to claim 1, wherein the installation member, the first contact component, and the second contact component are made of different metal materials.

9. The ground connection member according to claim 1, wherein the first contact component and the second contact component are identical.

10. A connector, comprising:
a housing;
multiple terminals provided in the housing and including multiple signal terminals and multiple grounding terminals; and
a ground connection member arranged in the housing, including:
an installation member having opposite first and second sides in a transverse direction of the ground connection member;
a first contact component assembled onto the first side of the installation member, the first contact component including multiple first elastic arms electrically contacting respective ones of the multiple grounding terminals; and
a second contact component assembled onto the second side of the installation member, the second contact component including multiple second elastic arms electrically contacting respective ones of the multiple grounding terminals, such that each grounding terminal is in electrical contact with both the first elastic arm and the second elastic arm simultaneously.

11. The connector according to claim 10, wherein the terminal and the ground connection member are detachably assembled into the housing.

12. The connector according to claim 10, wherein:
the multiple terminals are arranged in an upper row and a lower row, the multiple first elastic arms are arranged in an upper row and a lower row, and the multiple second elastic arms are arranged in an upper row and a lower row;
the upper row of first elastic arms are in electrical contact with the grounding terminals in the upper row of terminals, and the upper row of second elastic arms are in electrical contact with the grounding terminals in the upper row of terminals; and
the lower row of first elastic arms are in electrical contact with the grounding terminals in the lower row of terminals, and the lower row of second elastic arms are in electrical contact with the grounding terminals in the lower row of terminals.

13. The connector according to claim 12, wherein the housing includes:
a pair of end walls opposite to each other in a longitudinal direction of the housing; and
a retaining body connected between the pair of end walls and extends along the longitudinal direction, an upper row and a lower row of terminal installation slots are respectively formed on the upper and lower sides of the retaining body, the upper row of terminals are retained in the upper row of terminal installation slots, and the lower row of terminals are retained in the lower row of terminal installation slots.

14. The connector according to claim 13, wherein:
the retaining body has opposite front and rear sides on the transverse direction of the housing; and
the terminal includes:
a first cantilever portion extending from the front side of the retaining body and adapted to electrically contact a first circuit card;
a second cantilever portion extending from the rear side of the retaining body and adapted to electrically contact a second circuit card; and
a middle connection portion connected between the first cantilever portion and the second cantilever portion, the middle connection portion is installed and maintained in the terminal installation slot of the retaining body.

15. The connector according to claim 14, wherein:
a horizontal slot is formed on the retaining body perpendicular to the height direction of the housing, and the installation member of the ground connection member is inserted into the horizontal slot; and
the first contact component and second contact of the ground connection member are located on the front and rear sides of the retaining body and are assembled on both sides of the installation member.

16. The connector according to claim 15, wherein:
multiple accommodating slots are respectively formed on the front and rear sides of the retaining body, and each accommodating slot is in communication with a corresponding terminal installation slot; and
the first elastic arms and the second elastic arms are accommodated in the accommodating slots on the front and rear sides of the retaining body and are in electrical contact with the middle connection portion of the grounding terminal.

17. The connector according to claim 15, further comprising a pair of cover plates installed on the upper and lower sides of the housing and adapted to maintain the upper row of terminals and the lower row of terminals in the upper row of terminal installation slots and the lower row of terminal installation slots of the retaining body, a rib is formed on the cover plate, the rib is inserted into the terminal installation slot to press the middle connection portion of the terminal in the terminal installation slot.

18. The connector according to claim 17, wherein a slot hole is formed in the cover plate, and a protruding tongue is formed on the top surface of the side wall of the terminal installation slot, the protruding tongue is inserted into the slot hole.

19. The connector according to claim 17, wherein the housing further comprises a front wall connected between the pair of end walls and is spaced at a predetermined distance from the retaining body in the transverse direction, a post is formed on each of the upper and lower sides of the front wall, and an insertion hole is formed in the cover plate, the post is inserted into the insertion hole.

20. The connector according to claim 19, wherein:
upper and lower rows of positioning grooves are formed on the inner side of the front wall, and the ends of the first cantilever portions of the upper row of terminals and the lower row of terminals are r positioned in the upper and lower rows of positioning grooves; and
a card slot extending along the longitudinal direction is formed on the front wall and adapted to receive the first circuit card inserted between the first cantilever portions of the upper row of terminals and the first cantilever portions of the lower row of terminals.
